(19) United States
(12) Patent Application Publication
(10) Pub. No.: US 2022/0266302 A1
(43) Pub. Date: Aug. 25, 2022

(54) AUGER CONVEYOR WITH REMOVABLE SCREEN ATTACHMENTS AND METHOD OF USING SAME

(71) Applicants: Herman WIEBE, La Crete (CA); Jacob DRIEDGER, La Crete (CA)

(72) Inventors: Herman WIEBE, La Crete (CA); Jacob DRIEDGER, La Crete (CA)

(21) Appl. No.: 17/181,848

(22) Filed: Feb. 22, 2021

(51) Int. Cl. B07B 1/20; B07B 1/42; B07B 1/18; B07B 1/46

(52) U.S. Cl. CPC B07B 1/20; B07B 1/42; B07B 1/185; B07B 1/4645

(57) ABSTRACT

The present disclosure relates to an auger assembly that cleans the crop being conveyed during the auguring process. The assembly comprises a number of variously gauged rapidly removable screens that can be selected and easily installed in the assembly depending on the crop being conveyed, and the type of foreign material that is to be removed. A second auger then propels the foreign material to a waste collection port.

### FIELD OF INVENTION

The present disclosure relates to farming equipment, particularly to a screw auger conveyor, and more particularly to a screw auger conveyor with a removable screen attachment.

### BACKGROUND

Grains, seeds and crops that have been processed by threshing machines, such as a combine harvester, frequently contain undesired foreign particles such as soil, weed seeds, chaff, broken kernels and other foreign particles. It is necessary to remove such materials prior to storing the grain because these materials interfere with air flow when the grain is being dried and stored and can cause areas of spoiled grain.

Numerous different types of agriculture equipment are known that are able to clean and separate particular crops from the extraneous material. For example, some equipment uses winnowing techniques, wherein the uncleaned crops are tossed in a stream of moving air or dropped into a hopper that has forced air circulation. Other types of equipment use a combination of screening or sifting whereby the recently harvested crops are passed over one or more appropriately sized screens, the foreign matter being urged through the screens via augers or vibration.

Typically, such large pieces of farming equipment are centrally located, and farmers are required to bring their harvested crops to the central locations to have them screened. In the time it takes to transport the crops to the winnowing or screening facility, and then wait for other farmers' crops to be cleaned, significant spoiling of the crop may have occurred.

There is therefore a need for a piece of farming equipment that can be owned by individual farmers. The embodiments of the invention as disclosed herein have evolved with the general object of improving upon prior rotary auger conveyors to provide grain screening capabilities, which are portable, easy to use and which at the same time are inexpensive to manufacture, rugged and reliable.

### BRIEF SUMMARY

It is an object of the invention to provide an auger conveyor with removable screen attachments and method of using same.

In accordance with an aspect of the invention there is provided an essentially cylindrical crop cleaning device, said device comprising: a housing having first and second ends and first and second longitudinal opposing sides, said housing having defined within it an upper housing, configured to receive an upper fighting, and a lower housing, configured to receive a lower fighting; a lid having first and second ends and first and second longitudinal opposing sides configured to cooperate with said first and second ends and first and second longitudinal opposing sides of said housing; a plurality of hinges connecting said first side of said housing to said first side of said lid; a crop entry port positioned in said upper housing, partially on said first end of said housing and partially on said first end of said lid; a cleaned crop exit port, positioned in said upper housing, partially on said second end of said housing and partially on said second end of said lid; a screened area, within said upper housing and said lid, said screened area defining a path surrounding said upper fighting, between said crop entry port and said cleaned crop exit port; a lower fighting operationally installed in said lower housing; and a waste exit port situated in said lower housing towards said second end of said housing, wherein, when said upper fighting is installed, the crop to be cleaned is propelled along said path within said screened area, from said crop entry port through said cleaned crop exit port, waste materials that pass out of said screened area fall into said lower housing are are augured towards and through said waste exit port by said lower fighting.

In accordance with another aspect of the invention there is provided a method of cleaning a crop, using the claimed device, comprising the steps: installing an appropriate gauge of arced screen in said upper housing and said lid; securing said upper auger in said path defined by said screened area; attaching a transfer auger device to said crop entry port; attaching a transport or swing out auger to said cleaned crop exit port; activating said upper and lower flightings; and delivering crop to be cleaned into said transfer auger.

The advantages and features of the present invention will become better understood with reference to the following more detailed description and claims taken in conjunction with the accompanying drawings in which like elements are identified with like symbols.

### BRIEF DESCRIPTION OF THE DRAWINGS

To easily identify the discussion of any particular element or act, the most significant digit or digits in a reference number refer to the figure number in which that element is first introduced.

FIGS. 1A, 1B 1C illustrate aspects of the housing in accordance with one embodiment of the invention.

FIGS. 2A, 2B and 2C illustrate aspects of the upper housing in accordance with one embodiment of the invention.

FIGS. 3A, 3B 3C and 3D illustrate aspects of the complete assembly in accordance with one embodiment of the invention.

FIGS. 4A, 4B, 4C and 4D illustrate other aspects of the complete assembly in accordance with one embodiment of the invention.

FIGS. 5A, 5B, 5C and 5D illustrate aspects of the lid in accordance with one embodiment of the invention.

FIGS. 6A, 6B, 6C and 6D illustrate aspects of the housing in accordance with one embodiment of the invention.

FIGS. 7A, 7B and 7C illustrate aspects of the upper housing in accordance with one embodiment of the invention.

FIGS. 8A, 8B and 8C illustrate aspects of the complete assembly in accordance with one embodiment of the invention.

FIGS. 9A, 9B, 9C and 9D illustrate other aspects of the complete assembly in accordance with one embodiment of the invention.

FIGS. 10A, 10B, 10C and 10D illustrate aspects of the subject matter in accordance embodiments of the invention.

### DETAILED DESCRIPTION

Devices and methods for carrying out the invention are presented in terms of embodiments depicted within the FIGS. However, the invention is not limited to the described embodiments, and a person skilled in the art will appreciate that many other embodiments of the invention are possible without deviating from the basic concept of the invention, and that any such work around will also fall under scope of this invention. It is envisioned that other styles and configurations of the present invention can be easily incorporated into the teachings of the present invention, and the configurations shall be shown and described for purposes of clarity and disclosure and not by way of limitation of scope.

In one embodiment of the invention, the apparatus comprises of an essentially cylindrical body having a lower compartment or housing and a lid. The housing is sized and configured to receive upper and lower screw auger flightings, wherein the upper fighting is surrounded by removable screens. In operation, the crop to be cleaned is fed into one end of the upper screw auger area and the fighting causes foreign matter to pass through the screens into the bottom of the housing. The cleaned crop exits the other end of the upper screw auger area. The lower screw auger fighting propels the separated foreign matter to an exit port.

The various embodiments of the invention have fixtures and fittings along the edges of the housing to allow rapid and easy replacement of the screens. The screens may have differing gauges ranging down to 64th to accommodate seed & grain cleaning. The screens may be made from wire mesh, bar grading, perforated metal, channel grating, fiberglass grating, and can be made from a wide variety of materials including, aluminum, stainless, and plastic. Indeed, in some instances, when the crop to be augured does not need to be cleaned, the screens can be blank plates with no perforations.

The crop to be augured or cleaned may be delivered to the entry port on the housing by means known to those in the field including but not limited to transfer augers. Transfer augers typically have 8″ or 10″ diameter connector pipes, which attach directly to the entry port on the housing, and are powered by gas, electric or a hydraulic drive. These transfer augers have a low profile, usually less than 12″ high and are light and maneuverable thereby allowing the hopper of the transfer auger to fit under crop hopper bottom bins and trailers for fast and easy unloading.

After the crop has been cleaned, it exits the housing and is typically transported to the storage bins or hoppers or to transport trucks by way of a transport or swing out auger.

The features of the invention which are believed to be novel are particularly pointed out in the specification. The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

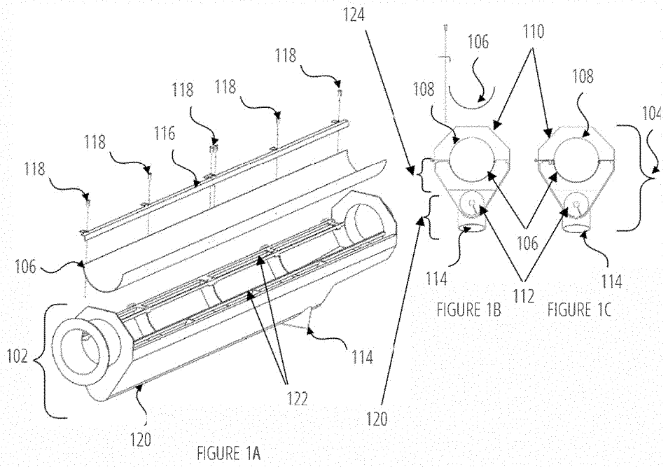

FIGS. 1A, B and C illustrate perspective (A) and end (B and C) views of an embodiment of the invention.

FIG. 1A shows the housing 102 that accommodates the lower screen 106 that is secured in place by an angled beam 116 that is attached to a ladder 122 on the housing 102 by means of fasteners 118.

FIGS. 1B and C show the complete assembly 104 comprising a lid 110 and a housing 102. The housing 102 comprises a lower housing 120 and an upper housing 124. The lower housing 120 accommodates a lower fighting 112 and has a waste exit port 114.

The upper screen 108 is sized and proportioned to fit within the lid 110, and is similarly attached to a ladder 122 along the outer edge of the lid 110 by means of fasteners 118.

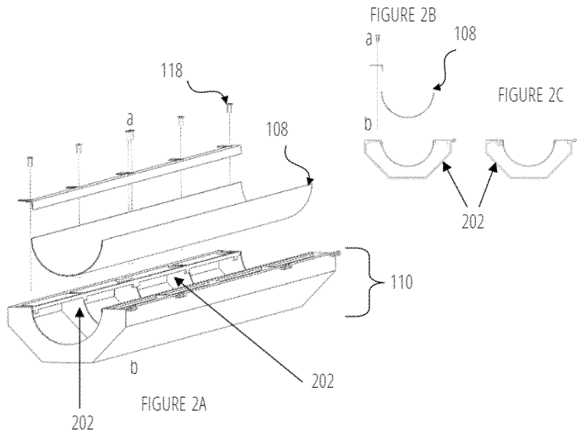

FIGS. 2A, B and C illustrate placement of upper rafters 202 that are positioned in the lid 110 to support the upper screen 108. In some instances, the upper screen 108 consists of two sections and is supported on an arced upper central support rafter 512. FIGS. 2B and C show a cross sectional view of the lid 110 taken across line a-b.

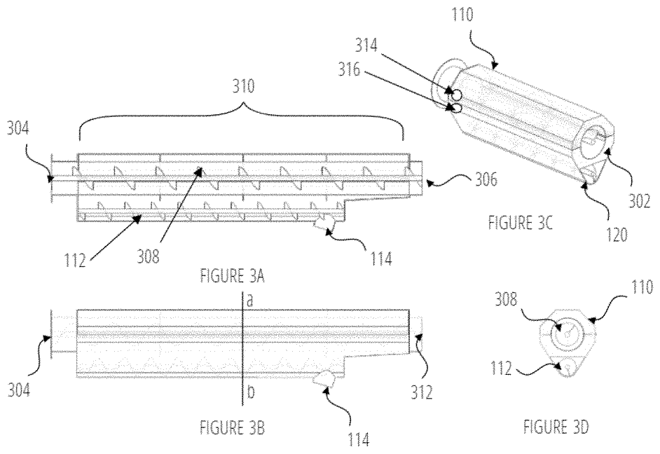

FIGS. 3A, B, C and D illustrate various views of the complete assembly 104.

FIGS. 3A and B show the relative positions of the lower fighting 112 in the lower housing 120 and the upper fighting 308 in the upper housing 124. The crop to be cleaned is augured into the crop entry port 304 by a transfer auger (not shown). The upper fighting 308 propels the crop to the cleaned along the entire length of the essentially cylindrical assembly 310. Particulate waste materials pass through the lower screen 106 and collect in the lower housing 120. The lower fighting 112 in the lower housing 120 then propels the waste material along the essentially cylindrical assembly 310 and out through the waste exit port 114.

FIG. 3C shows a perspective view of the complete assembly 104. In operation, the essentially cylindrical assembly 310 may be inclined such that the crop entry port 304 is lower than the cleaned crop exit port 306. Inclining the essentially cylindrical assembly 310 causes the crop to be cleaned to spend a longer period of time within the complete assembly 104 thereby removing more waste materials and creating a cleaner crop. The greater the angle of incline, the greater the length of time that the crop resides in the complete assembly 104 and the cleaner the augured crop. In some embodiments of the invention, a chain is affixed at a first attachment point 314 on the lid 110 and at a second attachment point 316 on the essentially cylindrical assembly 310. The length of the chain is selected to be of sufficient length to allow the lid to open fully, but to not cause the hinges 402 to sprain due to over extension.

FIG. 3D shows a cross sectional view of the complete assembly 104 taken along line a-b in FIG. 3B.

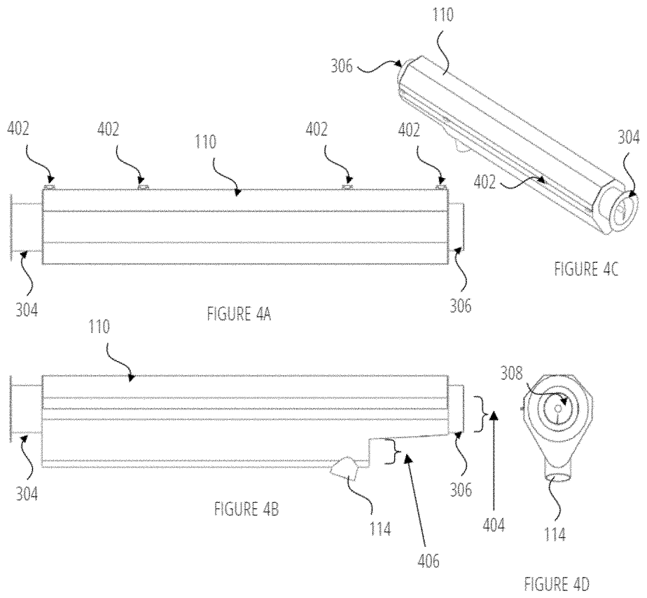

FIG. 4A, B, C, and D illustrate various embodiments of the complete assembly 104. The complete assembly 104 comprises the upper housing 124, lower housing 120 and lid 110. FIG. 4A shows a top view showing the lid 110 having several hinges 402 along one side of the complete assembly 104. The crop entry port 304 can be seen at one end of the assembly and the cleaned crop exit port 306 can be seen at the other end of the assembly. FIG. 4B shows a side view of the complete assembly 104. The crop entry port 304 and cleaned crop exit port 306 can be seen, along with the waste exit port 114. FIG. 4C is a perspective view of the complete assembly 104. FIG. 4D shows a cross sectional view of the complete assembly 104. The upper fighting 308 can be seen encompassed within the upper housing 124 and the lid 110.

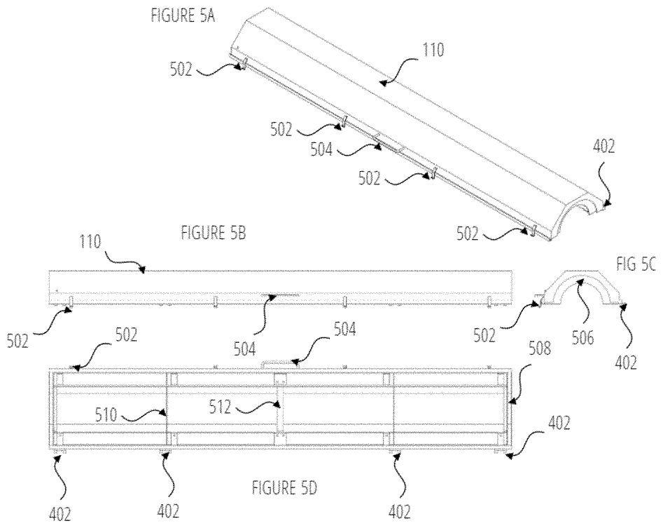

FIGS. 5A, B, C, and D illustrate various embodiments of the lid 110 assembly. FIG. 5A shows a perspective view of the lid 110. FIG. 5B shows a side view of the lid 110, featuring lid locks 502 attached along the opposite side of the lid 110 to the hinges 402. The lid 110 also features a handle 504 situated on the same side of the lid 110 to the lid locks 502. FIG. 5C is a cross sectional view of the lid 110. This figure shows the relative positions of the hinges 402, and the lid locks 502. Also illustrated is a watertight seal 506 that confers protection against snow and rain for the complete assembly 104. FIG. 5D illustrates an underside view of the lid 110. The watertight seals 506 can be seen at either end of the lid 110. An arced upper central support rafter 512 can be seen approximately midway along the lid 110. This arced upper central support rafter 512 serves to support the upper screen 108. In the embodiments of the invention having two upper screens 108, the arced upper central support rafter 512 supports the overlap of the upper screens 108.

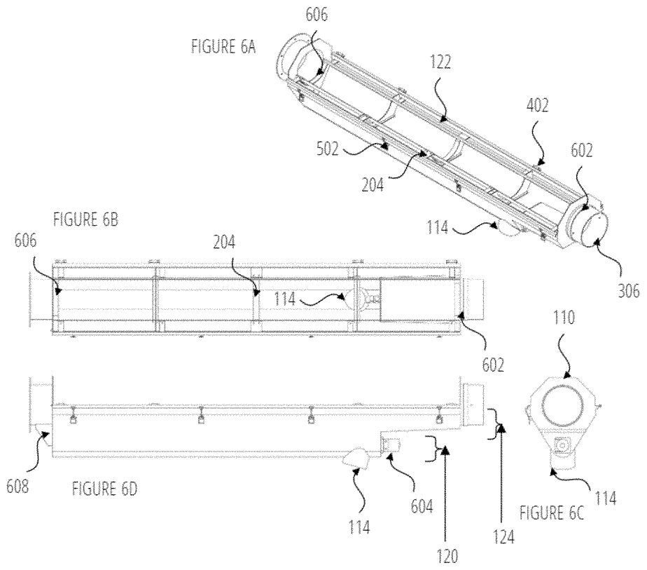

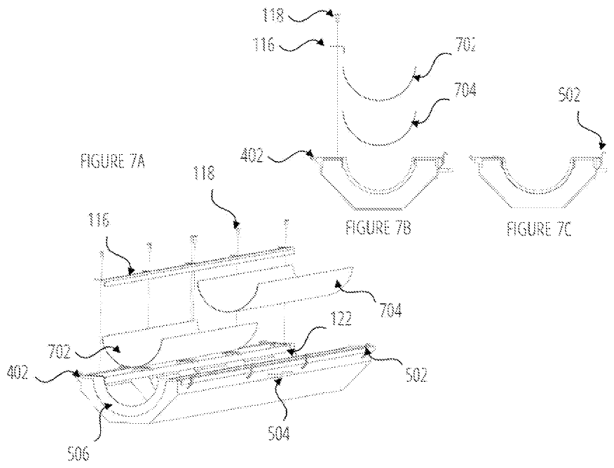

FIGS. 6A, B, C, and D illustrate various different housings 102 in accordance with different embodiments of the invention. The housing 102 comprises an upper housing 124 that partially accommodates the upper fighting 308 (not shown) and the lower housing 120 accommodates the lower fighting 112 (not shown). FIG. 6A shows a perspective of the housing 102 showing the hinges 402 and the lid locks 502. The ladders 122 along either side of the upper housing 124 are positioned to cooperate with the edges of the one or more lower screens 106. The arced ledge 608 and the upper rafters 202 function to support the one or more lower screens 106. A stopper 602 can be seen at the cleaned crop exit port 306, the function of the stopper 602 is to prevent the tube that transports the cleaned crop to the swing out auger from damaging the housing 102. FIG. 6B is a top view of the housing 102. The arced ledge 608 and r rafter 604 can be seen in more detail. FIG. 6C is a cross section view of the complete assembly 104. The position of the upper fighting 308 in the space formed by the upper housing 124 and the lid 110 can be seen. The lower fighting 112 can be seen within the lower housing 120. FIG. 6D shows a side view of the housing 102 clearly showing the upper housing 124 and lower housing 120. A hydraulic motor mount 606 can be seen mounted on the outer surface of the lower housing 120 that drives the lower fighting 112. Various different braces 610 may to welded onto the housing 102 at various different locations as and where additional support is needed.

FIGS. 7A and B illustrate the lid 110 with an embodiment having two upper screens 108. FIG. 7A shows how a first upper screen 702 and a second upper screen 704 nest into the lid 110 resting on the arced upper rafters 510. The first upper screen 702 and second upper screen 704 are secured in place by strips of angled beams 116 that clip over the upper edge of the upper screens 108. The angled beams 116 in turn are secured to the ladders 122 by numerous fasteners 118. The watertight seal 506 can clearly be seen, along with the handle 504, lid locks 502, and hinges 402. FIG. 7B is an exploded cross section view of the lid, showing in greater detail how the first upper screen 702 and second upper screen 704 are attached to the sides of the lid 110.

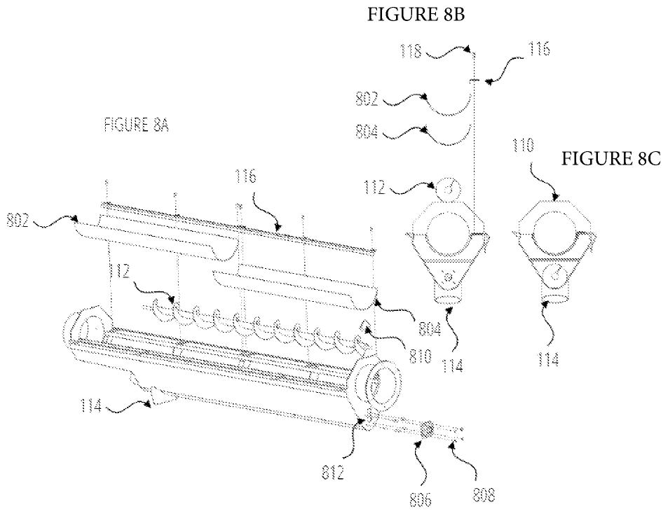

FIGS. 8A and B illustrate the complete assembly 104 in particular showing how the lower screens 106 are nested into the upper housing 124. FIG. 8A shows and exploded perspective view of the housing 102. The lower fighting 112 is secured in place in the lower housing 120 by means of a bearing 806 fastened in place using bearing bolts 808. An inner slot cover 810 is fastened over the slot 812 to prevent loss of grain during operation. The first lower screen 802 and second lower screen 804 are fastened in place resting on the arced ledges 608 and upper rafters 202. The edges of the lower screens 106 are clamped in place by the angled beams 116 that are secured to the ladders 122 by the fasteners 118, FIG. 8B is an exploded cross-sectional view of the complete assembly 104, showing in greater detail the attachment of the lower screens 106. And subsequent placement of the upper fighting 308 above the upper screens 108.

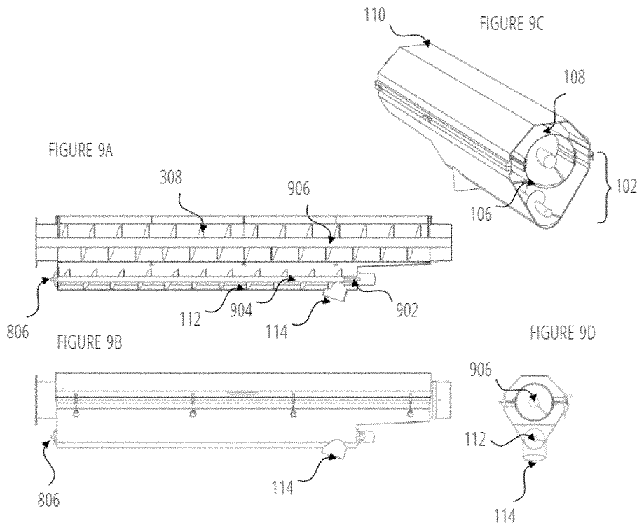

FIGS. 9A, B, C, and D illustrate various embodiments of the complete assembly 104. FIG. 9A shows a cross sectional side view of the housing 102 and lid 110. The position of the upper fighting 308 and lower fighting 112 can be seen. The upper fighting shafts 906 is secured in place at one end by a bearing 806 and at the other driven end by a cupper 902. FIG. 9B is a side view of the housing 102 and lid 110. The lid locks 502 can be seen securing the opening edge of the lid 110 to the upper housing 124. FIG. 9C is a perspective view of the complete assembly 104 demonstrating how the upper and lower ladders 122 abut thereby forming a continuous cylindrical screened in space that accommodates the upper fighting 308. FIG. 9D is a cross sectional view of the housing 102 and lid 110 assembly.

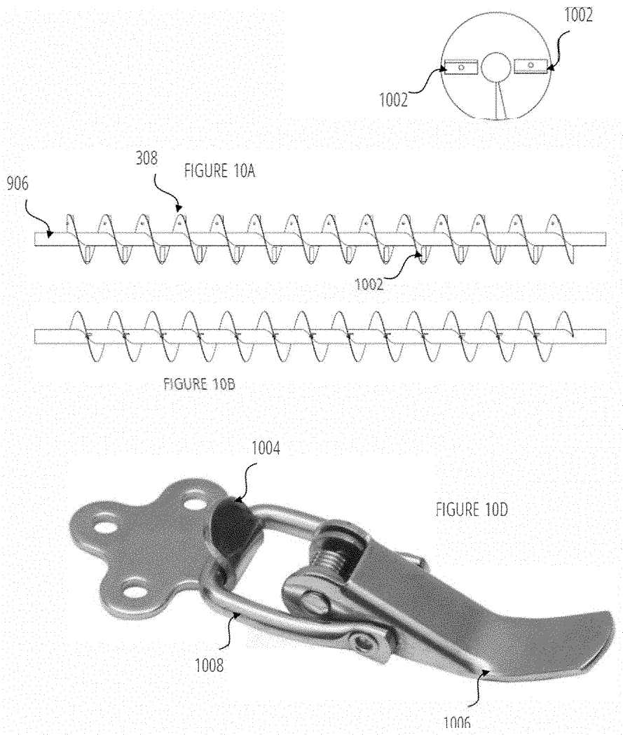

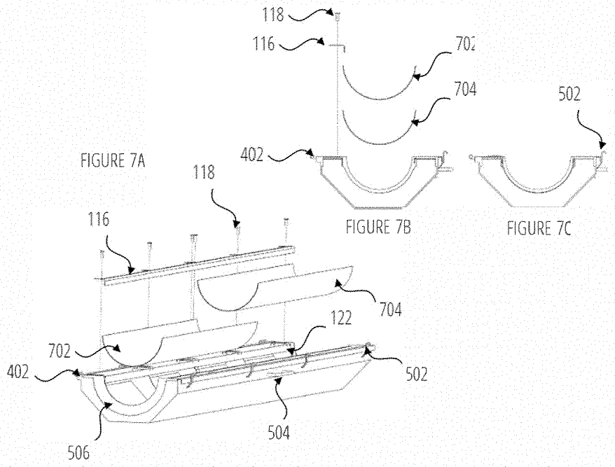

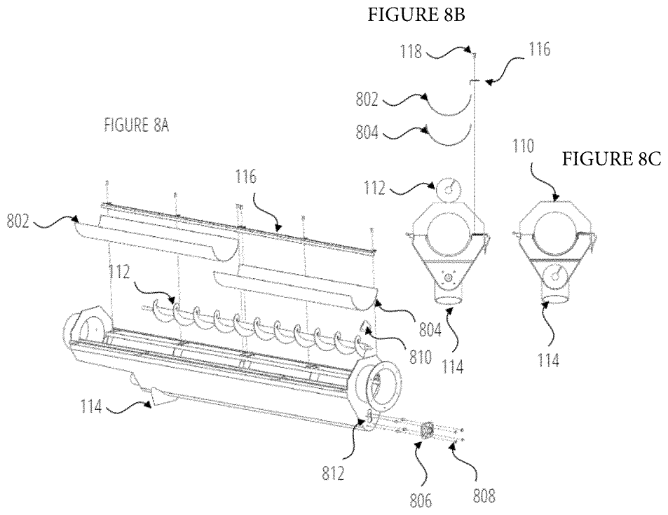

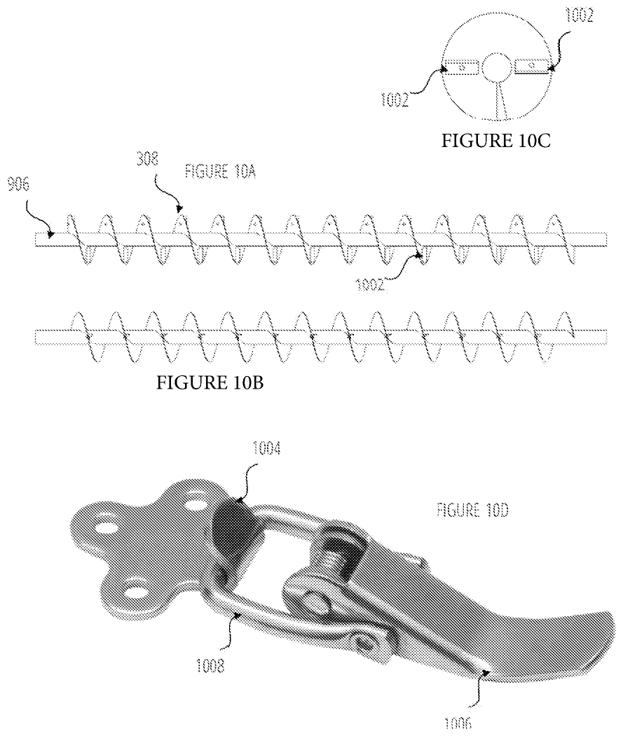

FIGS. 10A, B, and C illustrate a means of improving the cleaning of the seed, grains or crops within the upper housing 124. In one embodiment of the invention, the upper fighting 308 has paddles 1002 attached at intervals along the fighting. The paddles 1002, in this particular embodiment, are right angled sections that are bolted to the fighting. The paddles have the effect of disrupting the flow of the crops and thereby increasing the residency time within the screens. FIG. 10D shows a typical lid lock 502 system used to secure the lid 110 to the upper housing 124. In this embodiment, the lid lock 502 comprises a clip 1004 that may be attached to either the lid 110 or the upper housing 124 and a clasp 1008 that is activated by means of a lever 1006. Again the clasp 1008 and lever 1006 part of the assembly can be attached to the upper housing 124 or the lid 110.

In conclusion, variations in the embodiments of the invention as described herein include grain, seed, or crop cleaning devices having a frame or housing with a plurality of parallel augers or flightings mounted in the frame or housing for simultaneously auguring the grain, seed, or crop from one end of the device to the other end of the device, wherein the grain, seed, or crop is cleaned while auguring. The augers or flightings that transfer the grain, seed, or crop being surrounded by cylindrical screens. The screens having openings in their mesh smaller than the size of grain, seed, or crop so as to retain the grain, seed or crop within the cylindrical screens. The auguring action causes the grain, seeds, or crop to travel to a cleaned crop exit port at the end of the auger. The screens allow the chaff and other foreign particles smaller than the openings in the screens to travel out through the openings to clean the grain, seed, or crop. The smaller particles gravitating into the base or lower part of the frame or housing, beneath the screened auger(s) or flighting(s). An auger in the base or lower part of the frame or housing then augers the smaller particles out of a waste exit port to be collected and discarded.

As described herein, one particular embodiment of the invention is a device that provides an improved auguring technique using flightings and variously gauged screened area defining a path for grain to be cleaned. One of the flightings is located in an upper portion of the device and transports the crop to be cleaned through the screened area where it is separated from any contaminating material that it may contain, such as weeds, dirt and husks. The contaminating material falls through the appropriately gauged screens to another fighting which transports it to a waste port.

The device described herein can be mounted in between an apparatus, such as a transfer auger, that delivers the crop to be cleaned to a crop entry port 304 on the device, and an apparatus, for example a transport or swing out auger, then transports the cleaned crop to a storage facility or delivery wagon,

The transfer auger-type apparatus that delivers the crop to be cleaned to the currently claimed device can be of any of those known in the field of agriculture. Similarly, the transport or swing out auger that removes the cleaned crop from the currently claimed device can be of any known apparatus.

The crop entry port 304 and cleaned crop exit port 306 are typically 8″ or 10″ in diameter and the transfer auger and transport or swing out augers are selected to fit these dimensions respectively.

The positioning of the transfer auger and the transport or swing out auger, which are not part of the currently claimed device, can be positioned in locations to suit the geographical location of the process. The end of the currently claimed device, where the cleaned grain, seed or crop exits, can be elevated if required. The effect of tilting the currently claimed device causes the grain, seed or crop to be cleaned by travelling up an elevated angle. This tilting of the device causes the grain, seed, or crop increase its residency time within the augured screened area, causing a more thorough cleaning process.

In some embodiments of the invention, the upper fighting 308 may also have paddles 1002 attached at various intervals that causes the grain, seed, or crop being cleaned to be more thoroughly agitated. The paddles help to keep the screens clear, and prevent plugging of the grain, seed or crop being cleaned.

In one embodiment, it is contemplated that the auguring device is manufactured to fit one or more existing upper flightings 308, In another embodiment, the device may be manufactured to include a specific upper fighting 308 or range of upper flightings 308. The upper flightings 308 may be of any screw flight types, including standard, short long and variable pitch, notched/folded, and ribboned. The upper flightings 308 may be fitted with a variety of shapes and sizes of paddles to increase the residency of the crop in the device and thereby lead to a more thorough cleaning of the crop.

The screens that are fitted into the lid 110 and in the upper housing 124 can be selected to remove the specific type of garbage (weed seeds, dirt, etc.) from whole grains, seeds or crops. In one embodiment one screen may run the entire length of the device, being supported on the arced ledges 608 and upper and lower rafters 604, 604, 510, and 512, and secured in place by way of the angled beams 116, ladders 122 and fasteners 118. In an alternative embodiment of the invention, two or more screens may be installed within the lid and two or more further screens installed in the upper housing 124. In the embodiments having multiple screens, the screens are optionally overlapped and supported on arced ledges 608 and specifically widened central rafters 604 and 512. Again the screens are secured in place by way of angled beams 116, ladders 122 and fasteners. Since the size of the grain may vary it is intended that the mesh be smaller than at least a large majority of the grain being handled. However, it is contemplated to provide screens in several different size meshes for different size grain.

The ladders 122 comprise two parallel side rail pieces of metal, which may be strip, angle or box. Cross members are welded at intervals to opposing edges to form a ladder. Typically, four ladders 122 are used in the construction of each complete assembly 104. One of the side rails is attached to the inner ‘hinge’ edge of the upper housing 124, and another side rail is attached to the inner ‘opening’ edge of the upper housing 124. Another one of the side rails is attached to the inner ‘hinge’ edge of the lid 110, and another side rail is attached to the inner ‘opening’ edge of the lid 110. The angled beams 116 are then bolted to the opposing side rails, that extend horizontally into the upper housing 124 and lid 110, clipping the lower screen 106 and upper screen 108 in place. At certain points along the upper housing 124 and lid 110. The arced upper rafters 510 and upper rafters 202 support the abutting side rails of the opposing ladders 122.

The lid 110 on the device allows the apparatus to function in the rain or in damp conditions and thereby protects the grain, seed or crop being cleaned from becoming wet. It is important to keep the grain, seed and crops dry to prevent spoiling due to subsequent growth of mold. The lid 110 can be secured in place in the closed position by means of the lid locks 502 situated along the opening edge of the lid 110.

A chain, or some other mechanism, is fastened to the opening side of the lid 110 and the opening side of the upper housing 124 to prevent the lid 110from opening too far and thereby spraining the hinges 402 situated on the opposite sides of the lid 110 and upper housing 124.

Each end of the complete assembly 104 has a watertight seal 506 that cooperates with a water tight channel 508 around the crop entry port 304 and the cleaned crop exit port 306. In one embodiment this functionality is achieved by the lid 110 being fabricated to be a little bit narrower than the main body so that when the lid is closed it sits inside. Then there is a cap, such as a jeb cap, that extends over the outside edge such that when it rains, the water drips right off the edge and not into the housing 102. Moreover, the combination of the watertight seals 506 and water tight channels 508 and jeb cap prevents the interior of the complete assembly 104 from rusting.

When the cleaned crop exits the port 306 it may be collected in a box that is attached to the swing out auger. A connection pipe connects to a swing out auger and there is a stopper that encompasses the cleaned crop exit port 306. The box connection has a wall with a hole exactly the same size as the cleaned crop exit port 306. The wall is about a quarter inch thick, it sits right up again the stopper 602. The bolt-on connectors are bolted onto the opposing side of the box wall to stop the box wall and cleaned crop exit port 306 from sliding apart. This connection can still allow the swing out auger box and the cleaned crop exit port 306 to swivel.

Regarding the lower fighting 112, this can be powered either a small electric motor or by hydraulic means. The hydraulic or electric motor is mounted on the outer surface of the lower housing 120 that drives the lower fighting 112, as shown in FIG. 6. On the inside, of the lower housing 120 there is a cupper 902 which connects to the lower fighting shaft 904. On the other end of the lower fighting shaft 904 there is a bearing 806. The lower fighting 112 is easily removable by taking the bearing off and disconnecting the cupper 902 at the other end. The lower fighting 112 slides out from the slot 812, which then covered by the slot cover 810 which is held on by the bearing bolts 808.

Regarding the upper fighting 308, it runs from the crop entry port 304 to the cleaned crop exit port 306, connecting the grain, seed or crop in the transfer hopper to the connection box which is connected to the swing out auger. The box is a connection unit which allows it to turn 90 degrees. It connects to the bottom auger. The tractor turns the PTO which directly or indirectly turns both the swing out auger and the upper fighting 308.

The advantages conferred by the instantly claimed embodiments of the invention include the ability of the farmer being able to clean his grains, seeds or crops on his farm as opposed to having to take it to a cleaning facility. More importantly, it is possible to provide immediate grain, seed or crop cleaning system, which reduces spoilage. The device therefore saves time of transportation to facility and reduces cost associated with transporting to and using a cleaning facility cleaning.

The foregoing descriptions of specific embodiments of the present invention have been presented for purposes of illustration and description. They are not intended to be exhaustive or to limit the invention and method of use to the precise forms disclosed. Many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient, but is intended to cover the application or implementation without departing from the spirit or scope of the claims of the present invention.

1. A crop cleaning device comprising:
a housing having first and second ends, and first and second longitudinal opposing sides, said housing having an upper housing, and a lower housing;
an upper fighting mounted in the upper housing;
a lower fighting mounted in the lower housing;
a lid having first and second ends,. and first and second longitudinal opposing sides configured to cooperate with said first and second ends and first and second longitudinal opposing sides of said housing;
a hinge connecting said first side of said housing to said first side of said lid;
a crop entry port positioned in said upper housing, partially on said first end of said housing and partially on said first end of said lid;
a cleaned crop exit port, positioned in said upper housing, partially on said second end of said housing and partially on said second end of said lid;
an upper screen secured in the lid, and a lower screen secured in the upper housing separate from the upper screen, whereby when the lid is closed the upper screen and the lower screen define a screened area, within said upper housing and said lid, said screened area defining a path surrounding said upper fighting, between said crop entry port and said cleaned crop exit port; and
a waste exit port situated in said lower housing towards said second end of said housing,
wherein, when the crop to be cleaned is propelled along said path within said screened area, from said crop entry port through said cleaned crop exit port, waste materials that pass out of said screened area fall into said lower housing are augured towards and through said waste exit port by said lower fighting.

2. (canceled)

3. The device of claim 1 2, wherein said upper fighting includes paddles affixed at intervals therealong.

4. (canceled)

5. The device of claim 1 4, wherein said upper screen is installed onto said longitudinal opposing sides of said lid using pieces of angle metal and a plurality of removable fasteners, and
wherein said lower screen is installed on the upper housing using pieces of angle metal and a plurality of removable fasteners.

6. The device of claim 5, wherein said upper screen is supported in the lid at intervals along said path by a plurality of arced rafters.

7. The device of claim 4, wherein said crop entry port and said cleaned crop exit port further comprise arced ledges to support said upper screen and said lower screen.

8. The device of claim 1, further comprising a plurality of lid locks affixed to said second side of said housing to said second side of said lid.

9. The device of claim 8, wherein said plurality of lid locks are selected from clips, clasps and lever clasps.

10. The device of claim 1, further comprising a handle attached to said sad second side of said lid.

11. The device of claim 1, further comprising a non-extensible member that prevents said lid from over extending, said non-extensible member being attached to said second side of said housing to said second side of said lid.

12. The device of claim 11, wherein said non-extensible member is a chain.

13. The device of claim 1, wherein said lower fighting is attached to said first end of said housing by a bearing.

14. The device of claim 1, wherein said lower fighting is attached to said second end of said housing via a mechanical coupling.

15. The device of claim 1, wherein said lower fighting is configured to be hydraulically powered.

16. The device of claim 2, wherein said upper fighting is indirectly powered by a power-takeoff/PTO auger.

17. A method of cleaning a crop, using the device of claim 1, comprising the steps:
installing the upper screen and the lower screen with an appropriate gauge in said upper housing and said lid, respectively;
securing said upper auger in said path defined by said screened area;
attaching a transfer auger device to said crop entry port;
attaching a transport or swing out auger to said cleaned crop exit port;
activating said upper and lower flightings; and
delivering crop to be cleaned into said transfer auger.

18. The method of cleaning a crop, according to claim 17, further comprising the additional step of attaching paddles at intervals along said upper fighting.

19. The method of cleaning a crop, according to claim 17, further comprising the additional step of continually filling said transfer auger with crop to be cleaned.

20. The method of cleaning a crop, according to claim 17, further comprising the additional step of diverting waste materials that pass out of said screened area and through said waste exit port into a waste bin or container.
